(19) United States
(12) Patent Application Publication
(10) Pub. No.: US 2006/0091700 A1
(43) Pub. Date: May 4, 2006

(54) Force-transmission element

(76) Inventors: Juergen Decker, Schoenaich (DE); Joachim Herre, Tuebingen (DE); Hans-Juergen Mau, Sindelfingen (DE); Matthias Nohr, Esslingen (DE); Lutz Ristow, Dornstadt (DE); Alfred Schnabel, Althengstett (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/520,183

(22) PCT Filed: May 24, 2003
(86) PCT No.: PCT/EP03/05441

§ 371 Date: Aug. 31, 2005

(30) Foreign Application Priority Data
Jul. 6, 2002 (DE) 102 30 442.4

(51) Int. Cl. B60J 7/00; B62D 21/15

(52) U.S. Cl. 296/204; 280/784

(57) ABSTRACT

In order to increase the safety of vehicle occupants, in particular in order to reduce the stresses acting in a vehicle deceleration in the event of an impact, a force-transmission element (1) having two different levels is provided for an engine compartment. According to the invention this force-transmission element is incorporated into the force path which is initiated by the impact and it can be shifted from one level to another according to the position of the engine in the engine compartment.

### BACKGROUND AND SUMMARY OF THE INVENTION

This invention relates to a force-transmission element for an engine compartment, the element being arranged in front of an engine which is displaced inside the engine compartment in the event of an impact.

In the event of a vehicle impact against an obstacle the vehicle is abruptly braked, the energy of the moving vehicle being suddenly reduced. Because the vehicle is not rigid, the vehicle deceleration and hence the reduction of energy do not occur all at once but over a certain time. If the vehicle deceleration is plotted against the time, a so-called deceleration or acceleration (negative acceleration of the vehicle) characteristic curve is obtained. This deceleration characteristic curve varies as a function of the vehicle construction and—with respect to the front area of the vehicle—of what assemblies are arranged therein, so that each vehicle has a specific deceleration characteristic curve. It is particularly beneficial with regard to stresses acting on the vehicle occupants if the deceleration commences as early as possible and is then continued on the same level. Deceleration peaks, that is to say high rates of deceleration within a very brief time, which impose great stresses on vehicle occupants, are thereby avoided.

Deceleration values are lower if there are hollow spaces present in the vehicle, which do not present any resistance to the impact. This is because no energy can be dissipated through such hollow spaces. If such hollow spaces are arranged in front of an engine in a front area of a vehicle, for example, the greater part of the vehicle deceleration only commences once the hollow spaces in front of the engine have been telescoped and the cross member, the engine and the body structure start to form one block. This means that the greater part of the energy is only dissipated at the end over a short distance and in a very short time, which leads to those deceleration peaks and hence to heavy stresses acting on the vehicle occupants. During the telescoping of the hollow spaces, therefore, some time elapses which is not utilized for the absorption of energy.

The prior art discloses various force-transmission elements serving to reduce impact energy through deformation. For example, German document DE 100 07 789 A1 discloses an impact element, which is arranged in a vehicle front area between a cross member and an engine block. The function of the impact element is to reduce damage to the engine in order thereby to reduce repair costs. Its distinctive feature is that it has two levels connected in series and is incorporated into the force path which is introduced into the engine compartment in the event of an impact. A first reversible level directly faces the engine block and is composed of elastically deformable material. In the event of a minor impact, impact energy is introduced into the impact element and is reduced by deformation of the first level. The second level is an irreversible level, which is plastically deformed when a certain force threshold is exceeded and which is activated only in the event of a more heavy impact. In the event of an even larger impact, however, the greater part of the energy is only dissipated once the known force-transmission element has been deformed and the cross member, engine and body structure start to form one block.

An object of the present invention is to create a force-transmission element which further increases the safety of vehicle occupants, in particular one which reduces the stresses in the event of a vehicle deceleration due to an impact.

This object is achieved by a device having the features claimed.

The distinctive feature of the invention therefore is a force-transmission element which is arranged in the engine compartment and which has various levels, the shift from one level to another occurring according to the position of the engine in the engine compartment. The force-transmission element is incorporated into a force path which is produced by the force introduced into the engine compartment in the event of an impact. The arrangement according to the invention makes it possible, via the force-transmission element and according to the position of the engine in the engine compartment, to determine how much force is transmitted over this force path. This makes it possible to optimize the dissipation of energy in an engine compartment with in relation to the risk of injury to vehicle occupants. In other words, the force-transmission element according to the invention serves to distribute and to divert the impact force in the front structure of the vehicle so that a deformation occurs at a time favorable to the occupants and in a place favorable to the occupants.

For the purposes of the invention, the term “level” relates to various states which the force-transmission element can assume in respect of the force transmitted thereby. Depending on which level is activated, the force-transmission element can transmit force directly to other elements or can interrupt the force path, at least for a time.

It is feasible to initiate the transition from one level to the next if the engine impinges on a structure adjoining the engine compartment. In the event of a frontal impact this may be the body structure adjoining the engine compartment, for example, or the engine compartment rear bulk separating the engine compartment from the passenger compartment.

The means of initiating the transition from one level to the next level may also be activated after a predefined length of time. It is feasible to determine this predefined length of time with the aid of tests, the time selected being that at which the engine assumes a position which gives the most favorable result with regard to stresses acting on occupants. In order to determine the most favorable instant for the shift, it is also feasible to take account of the intensity or the severity of the accident.

The shift from one level to a further level can be effected by pyrotechnic elements, which are connected to a control unit operating in conjunction with sensors and from which said elements receive a signal at a desired instant. It is also feasible, however, to use other common actuators, such as electric motors, for example. It is also feasible to initiate a transition via a material failure of special components, a very precise adjustment of the system being important so that the failure occurs at the predefined instant.

According to one embodiment the force-transmission element according to the invention is arranged in front of the engine, so that the force introduced into the engine compartment by the impact is first introduced into the force-transmission element and only then into the engine itself. For example, it is possible to arrange the force-transmission element between the belt pulley plane and the radiator. If the force-transmission element occupies the entire space between these two elements, the impact force is introduced directly into the engine via the force-transmission element. The term directly in this context means that not much time elapses after the impact and that the front structure will not yet have been substantially deformed.

By means of this arrangement it is possible to influence the deceleration characteristic curve of a vehicle in such a way that the deceleration already commences at an early point in time, with the result that the overall acceleration values are reduced. In other words it is possible to achieve a protracted deceleration at a lower level. A most uniform acceleration with no aberrant peaks is thereby obtained over the entire distance available for deformation. This has a positive effect on the stresses acting on the occupants.

Further advantageous developments are set forth in the subordinate claims.

The invention will be described in more detail below with reference to the exemplary embodiments represented in the drawings.

### BRIEF DESCRIPTION OF THE DRAWINGS

FIG. 1 shows a sectional representation of a force-transmission element according to the invention in three different positions, and

FIG. 2 shows a side view of a further exemplary embodiment of a force-transmission element according to the invention.

### DETAILED DESCRIPTION OF THE INVENTION

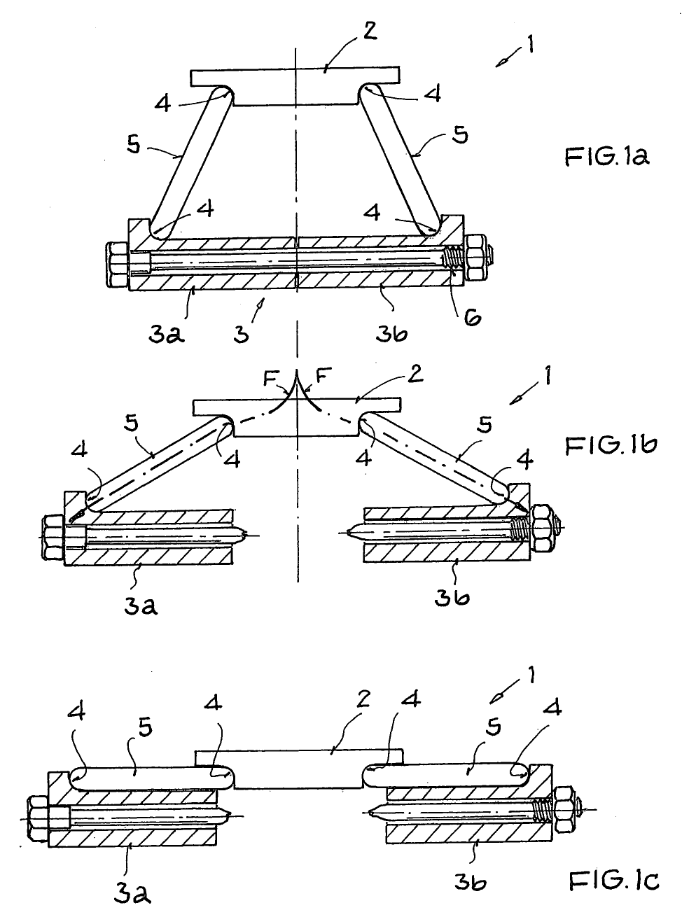

FIG. 1 shows a section through a force-transmission element 1 according to the invention. The force-transmission element 1 comprises a first impact plate 2 and a second impact plate 3 aligned parallel to the first plate. The two impact plates 2 and 3 have mountings 4, which serve to accommodate bars 5 arranged between the impact plates 2, 3. The bars 5 are arranged at a specific angle to the impact plates and serve to transmit force between the two impact plates 2, 3. In order to ensure a reliable transmission of force from one impact plate to the second impact plate via the bars 5, at least three bars are arranged between the impact plates 2, 3. If the reliable transmission of force is also ensured in some other way, it is also feasible to provide just two bars between the impact plates 2, 3.

The impact plate 3 is of multipart—in this case two-part—design construction. It comprises a part 3a and a part 3b. The two parts 3a and 3b of the impact plate 3 are connected to one another by a bolt 6.

In the state represented in FIG. 1a the force-transmission element is rigid, which means that it transmits forces up to a certain threshold without being deformed in the process. Both the impact plates 2, 3 and the bars 5 are designed, when under load, to transmit forces without themselves becoming deformed in the process. The single-part impact plate 2 may lie in front of the two-part impact plate 3 in the direction of introduction of the force. A force introduced into the force-transmission element is therefore first introduced into the one-part impact plate 2 and then into the multipart impact plate 3 via the bars 5.

The force-transmission element 1 may be arranged in front of the engine in an engine compartment. It is feasible to provide this between the belt pulley plane and the radiator.

The working principle of the force-transmission element 1 according to the invention will be explained below with reference to FIGS. 1b and 1c. When a vehicle strikes an obstacle in the event of a crash and the impact force is absorbed by a bumper unit, the force is then introduced into the force-transmission element 1. At this instant the force-transmission element 1 assumes the rigid state represented in FIG. 1a. At this level the forces are transmitted through the force-transmission element 1 into assemblies arranged behind the force-transmission element 1, in particular into an engine block. As a result a greater resistance is offered to the impact at a very early point in time, so that the deceleration of the vehicle likewise commences very early. As a result of the impact force being introduced into the engine, the engine is displaced rearwards in the engine compartment towards the body structure defining the rear boundary of the engine compartment. The bumper unit, force transmission element and engine therefore start to shift en bloc. Because an intrusion of engine compartment assemblies into a vehicle passenger compartment beyond a certain limit is undesirable, this shifting en bloc occurs only until the engine touches the rear area of the engine compartment, for example an engine compartment rear bulk, or until a certain degree of intrusion has developed depending on the intensity or severity of the accident.

As soon as the engine has reached this position the force-transmission element 1 experiences a transition to another level. This transition is triggered by the release of the connecting bolt 6 which connects the two impact plate parts 3a and 3b together. This can be achieved by pyrotechnic means, for example. Such a triggering of the transition has the advantage that it can occur very rapidly and the detected signal “engine touching the engine compartment rear bulk” can thereby be translated very rapidly. The timing of the transition can obviously also be made dependent upon other positions of the engine in the engine compartment.

As soon as the connecting bolt 6 is released, the impact energy, still not completely dissipated, causes the two impact plate parts 3a and 3b to be pushed apart. The path of the force in the force-transmission element 1 is identified by the arrows F in FIG. 1b. The shift from the first level to the second level means that while ever the impact plate 3 is being separated, no force can be transmitted by the force-transmission element 1. Any transmission of force is resumed only when the force-transmission element 1 assumes the position represented in FIG. 1c.

The force-transmission element 1, the first level of which has a certain expansion in the direction of the force path whilst being rigid when force is introduced, introduces the impact forces directly into the engine block, so that the latter is subject to deceleration at an early stage. Only when the engine touches the body structure does a shift to the second level of the force-transmission element 1 occur. The shift to the second level limits any deformation of the force-transmission element to a minimal expansion in the direction of the force path, so that once the engine comes into contact with the body structure, additional deformation travel is created, which prevents any intrusion of engine compartment assemblies into the passenger compartment. To sum up, the force-transmission element 1 according to the invention helps to influence the deceleration characteristic curve without shortening the overall deformation travel. The rigid first level serves to direct the energy initially into rear areas of the engine compartment, before then activating a second level, so that the proportions of the force-transmission element are abruptly minimized—deformation under low force level—and additional deformation zones are therefore freed up in the front area of the engine compartment. In this period hard force paths act via the deformation of front axle parts and the body structure, so that a uniform characteristic curve can be generated.

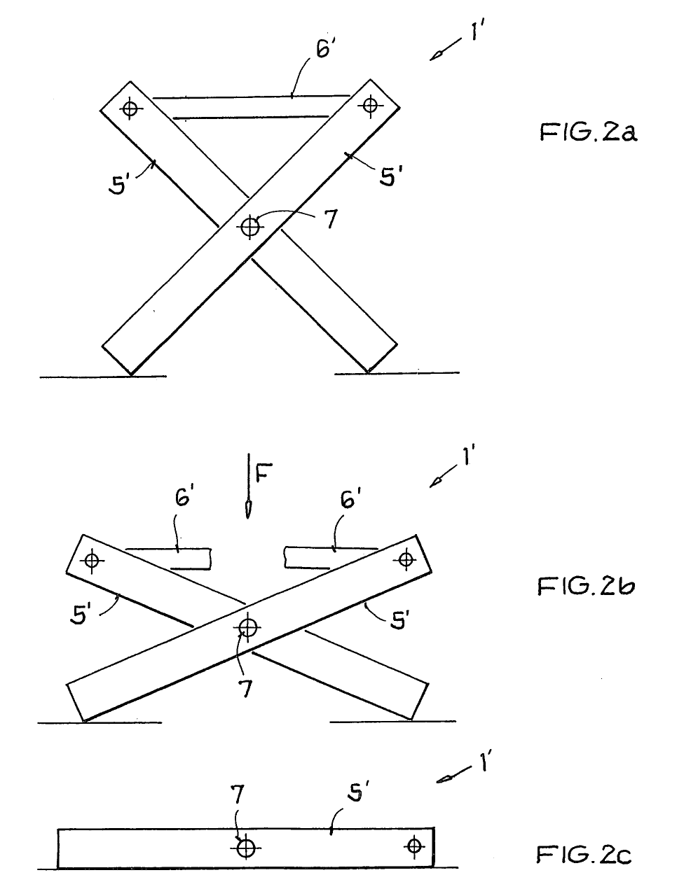

A further exemplary embodiment of a force-transmission element 1′ according to the invention, which comprises two intersecting bars 5′, is represented in FIGS. 2a to 2c. At the point of intersection of the bars 5′ a joint 7 is provided, which connects the two bars 5′ and enables the bars 5′ to perform a swivel movement in relation to one another.

At an outer end the bars 5′ are connected to one another by a parting bar 6′. FIG. 2a shows the starting position of the force-transmission element 1′ according to the invention; in this representation the force-transmission element 1′ assumes the first level. In order to ensure reliable functioning of the arrangement according to the invention, the force-transmission element 1′ must be arranged so that the parting bar 6′ is oriented perpendicular to a force introduction direction. The force introduction direction is indicated by the arrow F in FIG. 2b. FIG. 2b shows the transition from the first to the second level. The parting bar 6′ has been separated in the middle and the bars 5′ fold via the joint 7 in the direction of the arrows A. The parting of the parting bar is effected by the separating bolt 6 previously described. The final formation of the force-transmission element 1′ is shown in FIG. 2c. In this way the proportions of the force-transmission element 1′ are minimized. The working principle of the embodiment corresponds to the embodiment described with reference to FIGS. 1a to 1c.

In addition to the exemplary embodiments described, the shift from one level to another can also feasibly be produced by failure of a material structure or by flexible pressurized vessels in which pressure is abruptly relieved. These mechanisms are also capable of reducing the expansion of force-transmission elements within an extremely short time, thereby freeing up additional deformation zones.

1-18. (canceled)

19. A force-transmission element for an engine compartment having an engine which is displaced in the engine compartment when the severity of an impact exceeds a certain limit, the element being incorporated into a force path introduced into the engine compartment by the impact and having at least two different levels, wherein means which initiate a transition from one level to a further level according to a position of the engine in the engine compartment are provided.

20. The force-transmission element as claimed in claim 19, wherein the means initiate the transition when the engine impinges upon a structure defining the engine compartment.

21. The force-transmission element as claimed in claim 19, wherein the means initiate the transition when the engine impinges upon an engine compartment rear bulk.

22. The force-transmission element as claimed in claim 19, wherein the means initiate the transition pyrotechnically.

23. The force-transmission element as claimed in claim 19, wherein the means initiate the transition through material failure.

24. The force-transmission element as claimed in claim 19, wherein the element is arranged in front of the engine in the direction of introduction of the force.

25. The force-transmission element as claimed in claim 19, wherein the element comprises two impact plates spaced at an interval from one another.

26. The force-transmission element as claimed in claim 25, wherein the element further comprises bars arranged between the impact plates.

27. The force-transmission element as claimed in claim 26, wherein the bars are arranged at a specific angle to the impact plates.

28. The force-transmission element as claimed in claim 25, wherein the impact plates are fitted in mountings.

29. The force-transmission element as claimed in claim 25, wherein one of the two impact plates is of a two-part construction.

30. The force-transmission element as claimed in claim 29, wherein the two-part construction includes two parts which are detachably connected to one another.

31. The force-transmission element as claimed in claim 30, wherein the two parts are connected to one another by a separating bolt.

32. The force-transmission element as claimed in claim 19, wherein the element it has at least two intersecting bars.

33. The force-transmission element as claimed in claim 32, wherein the two bars are pivotally connected to one another.

34. The force-transmission element as claimed in claim 32, wherein the intersecting bars are connected to one another by a parting bar at outward point ends of the interesting bars.

35. The force-transmission element as claimed in claim 34, wherein the parting bar has a two-part construction, and wherein the two-part construction includes two parts which are detachably connected to one another.

36. The force-transmission element as claimed in claim 35, wherein the two parts are connected to one another by a separating bolt.

37. The force-transmission element as claimed in claim 20, wherein the means initiate the transition pyrotechnically.

38. The force-transmission element as claimed in claim 20, wherein the means initiate the transition through material failure.
